(19) United States
(12) Patent Application Publication
(10) Pub. No.: US 2009/0185148 A1
(43) Pub. Date: Jul. 23, 2009

(54) SUPPORT FOR AN OPTICAL ELEMENT

(75) Inventors: Yim-Bun Patrick Kwan, Aalen (DE); Stefan Xalter, Oberkochen (DE); Herman M.J.R. Soemers, Mierlo (NL); R. de Weerdt, Hoogstraten (BE); A.F. Benschop, Veldhoven (NL); Bernard Stommen, Geldrop (NL); Frans van Deuren, Valkenswaard (NL)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/358,722

(22) Filed: Jan. 23, 2009

Related U.S. Application Data
(63) Continuation of application No. PCT/EP2007/057689, filed on Jul. 25, 2007.
(60) Provisional application No. 60/923,000, filed on Apr. 12, 2007.
(60) Provisional application No. 60/833,227, filed on Jul. 25, 2006.

(30) Foreign Application Priority Data
Jul. 25, 2006 (EP) 06117813.3

(51) Int. Cl. G03B 27/32; G02B 7/02

(52) U.S. Cl. 355/18; 359/819

(57) ABSTRACT

The disclosure relates to a support structure for an optical element and an optical element module including such a support structure. The disclosure also relates to a method of supporting an optical element. The disclosure may be used in the context of photolithography processes for fabricating microelectronic devices, such as semiconductor devices, or in the context of fabricating devices, such as masks or reticles, used during such photolithography processes.

### CROSS-REFERENCE TO RELATED APPLICATIONS

This application is a continuation of, and claims priority under 35 U.S.C. §120 to, international application PCT/EP2007/057689, filed Jul. 25, 2007, which claims benefit of U.S. Provisional Application Ser. No. 60/923,000, filed Apr. 12, 2007, and Ser. No. 60/822,227, filed Jul. 25, 2006, and European patent application 06 117 813.3, filed Jul. 25, 2006. International application PCT/EP2007/0576 is incorporated by reference herein in its entirety.

### FIELD

The disclosure relates to a support structure for an optical element and an optical element module including such a support structure. The disclosure also relates to a method of supporting an optical element. The disclosure may be used in the context of photolithography processes for fabricating microelectronic devices, such as semiconductor devices, or in the context of fabricating devices, such as masks or reticles, used during such photolithography processes.

### BACKGROUND

Semiconductor devices are undergoing miniaturization. Accordingly, it is desirable for the good performance of the optical system used in the exposure process during semiconductor fabrication. The same can hold for auxiliary systems participating in the fabrication process, such as the support structure supporting the semiconductor device, e.g. a wafer, to be manufactured.

### SUMMARY

In some embodiments, the disclosure provides an optical element module and a support to an optical element, respectively, that may be used for highly dynamic positioning applications with larger positioning ranges, such as positioning ranges of 10 mm and more.

In certain embodiments, the available positioning range of an actuating support structure for an optical element is increased by a relatively simple approach while maintaining the influence of the actuation on the imaging accuracy of the optical element as low as possible.

The disclosure is based, in part at least, on the understanding that a highly dynamic introduction of forces into an optical element, e.g. for a gravity compensation allowing increased positioning ranges without deteriorating the imaging accuracy or for actuating and/or deforming an optical element, may be achieved by using a negative pressure for generating a force that acts on the optical element. The force generated using the negative pressure and acting on the optical element may be used for any desired purpose. For example, such a force may be used for counteracting the gravitational force acting on the optical element to be supported or for generating a force actuating the optical element, such as, positioning and/or deforming the optical element. For example, when using the disclosure for a pressure based gravity compensation or any other purpose, due to the simple pressure control that may be achieved, the force generated using the negative pressure may be easily kept at least close to its optimum value over a virtually unlimited range of motion, e.g. over a virtually unlimited positioning range of the optical element. Since virtually no energy has to be supplied to the system in proximity of the optical element the problem of heat generation and introduction into the optical system under static load conditions is largely avoided.

Furthermore, apart from the simple pressure control that may be achieved, the use of a negative pressure has the advantage that a lower mass of working medium can be conveyed when shifting part of the optical element or even the entire the optical element (e.g. during positioning the optical element). Thus, a lower inertia and lower internal friction can be dealt with leading to improved dynamic properties of the system. Furthermore, the use of the negative pressure can simply eliminate the contamination problem since there is no material transport through any eventual sealing gap of the force exerting device used towards the surroundings of the optical element. This can be particularly valid if a gaseous working medium is used. However, a liquid medium may also be used.

Furthermore, the force exertion may be achieved in a simple and space saving manner by implementing a simple bellows or a simple cylinder and piston arrangement forming a negative pressure chamber wherein the negative pressure is provided by a suitable negative pressure source. The control keeping, for example, the gravity compensation force substantially equal to the gravitational force acting on the optical element during the positioning process may be a simple pressure control. It may be provided, for example, via a pressure sensor providing the actual level of negative pressure to a suitable control device adjusting the negative pressure to a given setpoint value.

It will be appreciated that, positioning ranges—i.e. a travel of the optical element from one extreme position to its other extreme position—of more than 10 mm to 30 mm, even more than 50 mm may be achieved at substantially optimized gravity compensation force. This may be done within a very short interval of less than two seconds, even less than one second.

In some embodiments, the disclosure provides an optical element module including an optical element and a support structure supporting the optical element. The support structure includes a force exerting device that is mechanically connected to the optical element and adapted to exert a force on the optical element when a negative pressure is acting within the force exerting device.

In certain embodiments, the disclosure provides an optical element module including an optical element and a support structure supporting the optical element. The support structure includes an actuator device and a gravity compensation device. The actuator device is mechanically connected to the optical element and adapted to exert an actuation force on the optical element. The actuation force accelerates the optical element. The gravity compensation device includes a gravity compensator. The gravity compensator is mechanically connected to the optical element and adapted to exert a gravity compensation force on the optical element when a negative pressure is acting within the gravity compensator. The gravity compensation force counteracts at least a part of the gravitational force acting on the optical element. It will be appreciated here that more than one gravity compensator may be used to fully compensate the gravitational force acting on the optical element.

In some embodiments, the disclosure provides an optical exposure apparatus for transferring an image of a pattern formed on a mask onto a substrate. The apparatus includes an illumination system adapted to provide light of a light path, and a mask unit located within the light path and adapted to receive the mask. The apparatus also includes a substrate unit located at an end of the light path and adapted to receive the substrate. The apparatus further includes an optical projection system located within the light path between the mask location and the substrate location and adapted to transfer an image of the pattern onto the substrate. The illumination system and/or the optical projection system includes an optical element module. The optical element module includes an optical element and a support structure supporting the optical element. The support structure includes a force exerting device that is mechanically connected to the optical element and adapted to exert a force on the optical element when a negative pressure is acting within the force exerting device.

In certain embodiments, the disclosure provides an optical exposure apparatus for transferring an image of a pattern formed on a mask onto a substrate. The apparatus includes an illumination system adapted to provide light of a light path, and a mask unit located within the light path and adapted to receive the mask. The apparatus also includes a substrate unit located at an end of the light path and adapted to receive the substrate. The apparatus further includes an optical projection system located within the light path between the mask location and the substrate location and adapted to transfer an image of the pattern onto the substrate. The illumination system and/or the optical projection system includes an optical element module.

In some embodiments, the disclosure provides a support structure for supporting an optical element. The support structure includes a force exerting device adapted to be mechanically connected to the optical element and to exert a force on the optical element when a negative pressure is acting within the force exerting device.

In certain embodiments, the disclosure provides support structure for supporting an optical element including an actuator device and a gravity compensation device. The actuator device is adapted to be mechanically connected to the optical element and to exert an actuation force on the optical element. The actuation force accelerates the optical element. The gravity compensation device includes a gravity compensator adapted to be mechanically connected to the optical element and to exert a gravity compensation force on the optical element when a negative pressure is acting within the gravity compensator. The gravity compensation force counteracts at least a part of the gravitational force acting on the optical element.

In certain embodiments, the disclosure provides a method of supporting an optical element. The method includes providing an optical element and a force exerting device and supporting the optical element. Supporting the optical element includes exerting a force on the optical element via the force exerting device, where the force is generated using a negative pressure.

In some embodiments, the disclosure provides a method of supporting an optical element including providing an optical element and a gravity compensation device, exerting a gravity compensation force on the optical element via the gravity compensation device, the gravity compensation force counteracting at least a part of the gravitational force acting on the optical element. The exerting the gravity compensation force includes generating the gravity compensation force using a negative pressure.

It will be appreciated in this context that more than one gravity compensator and gravity compensation force, respectively, may be used to fully compensate the gravitational force acting on the optical element. However, is also possible that the full gravity compensation of the optical element is provided by one single gravity compensator and gravity compensation force, respectively.

Optionally, the above aspects of the disclosure are used in the context of microlithography applications. However, it will be appreciated that the disclosure may also be used in any other type of optical exposure process or any other type of supporting an element being either an optical or not.

Further embodiments of the disclosure will become apparent from the dependent claims and the following description with reference to the appended drawings, in which:

### BRIEF DESCRIPTION OF THE DRAWINGS

FIG. 1 is a schematic representation of an optical exposure apparatus including an optical element module with a support structure;

FIG. 2 is a schematic view of an optical element module that may be used in the optical exposure apparatus of FIG. 1;

FIG. 3 is a schematic view of an optical element module that may be used in the optical exposure apparatus of FIG. 1;

FIG. 4 is a schematic view of an optical element module that may be used in the optical exposure apparatus of FIG. 1;

FIG. 5 is a schematic view of an optical element module that may be used in the optical exposure apparatus of FIG. 1;

FIG. 6 is a schematic view of a part of an optical element module that may be used in the optical exposure apparatus of FIG. 1; and

FIG. 7 is a schematic view of a part of an optical element module that may be used in the optical exposure apparatus of FIG. 1.

### DETAILED DESCRIPTION

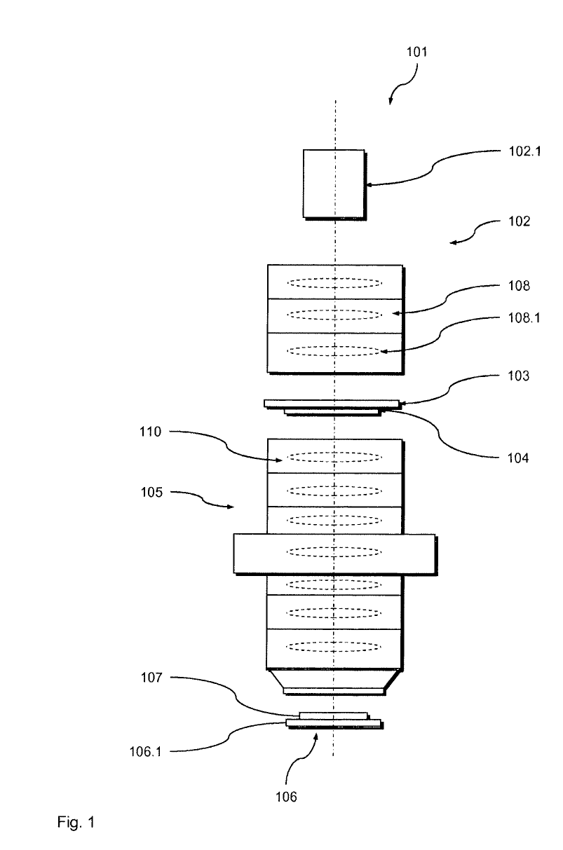

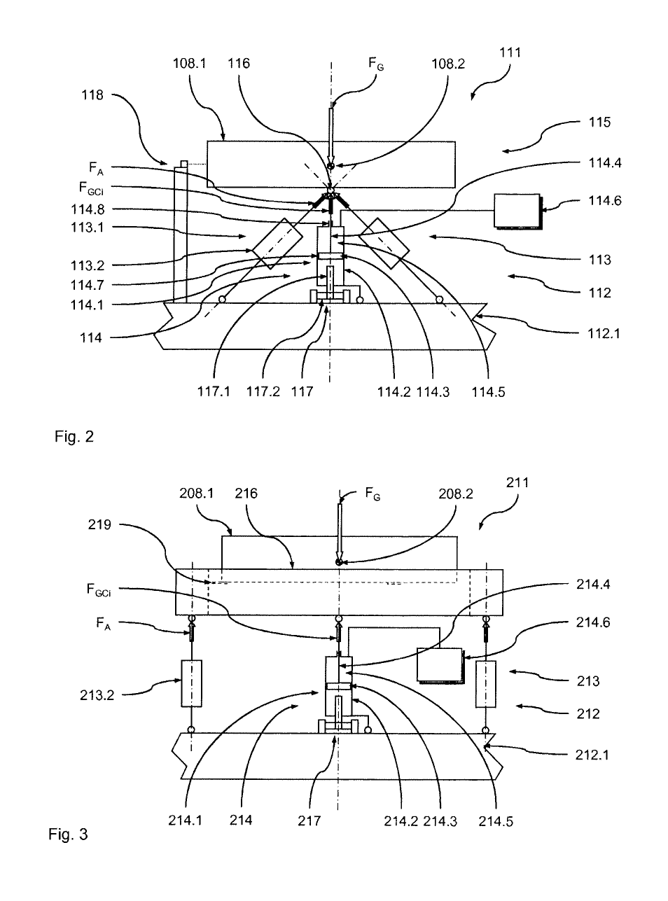

An optical exposure apparatus 101 includes an illumination system 102, a mask unit 103 holding a mask 104, an optical projection system 105 and a substrate unit 106 holding a substrate 107 will be described with reference to FIGS. 1 and 2.

The optical exposure apparatus is a microlithography apparatus 101 that is adapted to transfer an image of a pattern formed on the mask 104 onto the substrate 107. To this end, the illumination system 102 illuminates the mask 104 with exposure light. The optical projection system 105 projects the image of the pattern formed on the mask 104 onto the substrate 107, e.g. a wafer or the like.

The illumination system 102 includes a light source 102.1 and a first optical element group 108 with a plurality of optical elements cooperating to define the beam of exposure light—schematically indicated by the double-dot-dashed contour 109 in FIG. 1—by which the mask 104 is illuminated. The optical projection system 104 includes a second optical element group 110 with a plurality of optical elements cooperating to transfer an image of the pattern formed on the mask 104 onto the substrate 107.

The light source 102.1 provides light at a wavelength of 193 nm. Thus, the optical elements of the first optical element group 108 and the second optical element group 110 are refractive and or reflective optical elements, i.e. lenses, mirrors or the like. However, it will be appreciated that, in embodiments operating at different wavelengths, such as in the so called EUV range (i.e. at a wavelength between 5 nm and 20 nm, typically about 13 nm), any types of optical elements, e.g. lenses, mirrors, gratings etc. may be used alone or in an arbitrary combination.

During the exposure process, the wafer 107 is temporarily supported on a wafer table 106.1 forming part of the substrate unit 106. Depending on the working principle of the of the microlithography apparatus 101 (wafer stepper, wafer scanner or step-and-scan apparatus) the wafer 107 is moved at certain points in time relative to the optical projection system 105 to form a plurality of dies on the wafer 107. Once the entire wafer has been exposed, the wafer 107 is removed from the exposure area and the next wafer is placed in the exposure area.

Depending on the working principle of the microlithography apparatus 101, when switching from one die to the next die and/or from one wafer to the next wafer, the illumination setting of the illumination system 102 has to be rapidly changed frequently. To this end, the position of an optical element in the form of a lens 108.1 of the first optical element group 108 has to be rapidly changed in order to achieve a high throughput of the microlithography apparatus 101.

As can be seen from FIG. 2, the lens 108.1—shown in a highly schematic manner—forms part of an optical element module 111. The optical element module 111 includes a support structure 112 supporting the lens 108.1. The support structure 112, in turn, includes a base structure 112.1, an actuator device 113 and a force exerting device in the form of a gravity compensation device 114.

The actuator device 113 includes three actuator pairs 113.1 (only one of them being shown in FIG. 1 for reasons of clarity). The actuator pairs 113.1 are evenly distributed at the perimeter of the lens 108.1.

Each actuator pair 113.1 includes two contactless actuators 113.2, such as voice coil motors (Lorentz actuators) or the like, each mechanically connected to the base structure 112.1 and the lens 108.1. The actuator device 113 serves to accelerate and, thus, to position the lens 108.1. To this end, it exerts a corresponding actuation force on the lens 108.1 as will be explained in greater detail below.

The gravity compensation device 114 includes three gravity compensators 114.1 each of them being associated to one of the actuator pairs 113.1. Thus, the gravity compensators 114.1 as well are evenly distributed at the perimeter of the lens 108.1. Each gravity compensator 114.1 is mechanically connected to the base structure 112.1 and the lens 108.1.

The gravity compensation device 114, in sum, exerts a total gravity compensation force F_{G}ct which counteracts and fully compensates the gravitational force F_{G} acting in the center of gravity (COG) 108.2 of the lens 108.1. Depending on the mass distribution of the lens 108.1 the individual gravity compensation forces F_{G}& exerted by the respective gravity compensator on the lens 108.1 are chosen such that, together, they fully compensate and balance the static forces and moments acting on the lens 108.1. It will be appreciated that, depending on the design of the actuators 113.2, eventually, this may also include forces and/or moments resulting from the weight of certain components of the actuator device 113 mechanically connected to the lens 108.1.

In other words, under static load conditions, the individual gravity compensation forces F_{G}& exerted by the individual gravity compensators 114.1 are selected such that the sum ΣF_{COG} of all forces acting in the centre of gravity 108.2 and the sum ΣM_{COG} of all moments acting in the centre of gravity 108.2 is zero, i.e.:

ΣF_{COG}=0, (1)

ΣM_{COG}=0. (2)

To this end, each gravity compensator 114.1 includes a cylinder 114.2 and a piston 114.3 slidably mounted within the cylinder 114.2. A piston rod 114.4 guided in a suitable bush of the cylinder 114.2 mechanically connects the piston 114.3 to the lens 108.1. The cylinder 114.2 and the piston 114.3 define a negative pressure chamber 114.5. A negative pressure source 114.6 provides a suitable negative pressure NP within the negative pressure chamber 114.5.

This negative pressure provided by the negative pressure source 114.6 corresponds to a negative pressure setpoint value NP₅ which is selected such that, under static load conditions, the above equations (1) and (2) or are fulfilled, i.e. the desired individual gravity compensation force F_{G}& as outlined above is exerted via the piston rod 114.4 on the lens 108.1.

The negative pressure source 114.6 includes a simple pressure control which controls the negative pressure NP using the negative pressure setpoint value NP₅. In other words, the pressure control tries to maintain the negative pressure NP within the negative pressure chamber 114.5 as close as possible to the negative pressure setpoint value NP_{S} at any time.

The pressure control may be fully integrated within the negative pressure source. However, it is also possible, for example, that a suitable pressure sensor of the pressure control is provided within or close to the cylinder 114.2 in order to reduce the reaction time of the control.

The actuator device 113 is optionally arranged to position the lens 108.1 in more than one degree of freedom (DOF), optionally in up to all six degrees of freedom (DOF). Depending on the positioning movement provided by the actuator device the location and/or orientation of the lens 108.1 may change such that the negative pressure setpoint value NP₅ has to be adjusted accordingly in order to achieve fulfillment of the above equations (1) and (2) under static load conditions for this location and/or orientation of the lens 108.1. Thus, a corresponding control of the negative pressure setpoint value NP_{S} may be superimposed to the negative pressure control as outlined above.

It will be appreciated that, in certain embodiments, the control of the negative pressure setpoint value NP₅ may be performed as a function of an operational parameter of the actuator device 113 optionally being representative of the power taken up by the actuator device 113. This may be done in order to reduce the power consumed and, thus, the heat generated by the actuator device 113. For example, it is possible to adjust the negative pressure setpoint value NP₅ as a function of the electrical current taken by the actuator device 113.

The control of the negative pressure setpoint value NP_{S} and, thus, of the negative pressure within the negative pressure chamber 114.5 can be provided at a low bandwidth, optionally at less than 5 Hz, such that the control does substantially not interfere with the dynamic position control of the lens 108.1 provided via the actuator device 113. Thus, the current taken and, consequently, the power consumed by the actuator device 113 may be reduced, both, under static load conditions as well as even under dynamic load conditions. This leads to an overall reduction of the heat generated within the actuator device 113 and, thus, within the optical system reducing thermally induced problems such as thermally induced degradation of imaging quality.

Thanks to the use of a negative pressure on the gravity compensation device 114 has very short reaction times and thus very good dynamic properties. This is due to the fact that, as already outlined above, only a rather low mass of working medium is to be conveyed within the negative pressure chamber 114.5, within the negative pressure lines connecting the negative pressure chamber 114.5 and the negative pressure source 114.6 and within the components of the negative pressure source 114.6 when positioning the optical element 108.1. Thus, a low inertia and a low internal friction on the working medium is to be dealt with leading to improved dynamic properties of the system.

It will be appreciated that the negative pressure NP is provided to be negative in relation to the pressure prevailing in the atmosphere 115 outside the negative pressure chamber 114.5 and surrounding the lens 108.1.

Thus, furthermore, the use of the negative pressure NP simply eliminates the contamination problem since there is no material transport through any sealing gap, such as the gap 114.7 formed between the cylinder 114.2 and the piston 114.3 and the gap 114.8 formed between the cylinder 114.2 and the piston rod 114.4, towards the atmosphere 115 surrounding the lens 108.1. On the contrary, if any, there is only material transport from the atmosphere 115 towards the negative pressure chamber 114.5.

However, it will be appreciated that, in some embodiments, it may be provided that there is no material flow between the negative pressure chamber and the atmosphere surrounding it, e.g. by providing suitable seals such as highly compliant membrane seals or the like. In this case the negative pressure within the negative pressure chamber may also be only negative in relation to an atmosphere prevailing within a further pressure chamber within the cylinder and lying on the opposite side of the piston. This further pressure chamber is then also sealed from the atmosphere surrounding the lens.

The lens 108.1 may be positioned over a range of more than 50 mm within less than 1 s. Furthermore, accelerations up to 100 m/s² may be achieved with lenses (or other optical elements) weighing 5 kg and more.

As can be seen from FIG. 2, the gravity compensator 114.1 and the actuators 113.2 of the associated actuator pair 113.1 contact the lens 108.1 in a single interface 116 in such a manner that the gravity compensation force line of the individual gravity compensation force F_{GCI} and the actuation force line of the respective actuation force F_{A} intersect at the interface 116. Thus, an advantageous three-point support is provided to the lens 108.1.

As can be also seen from FIG. 2, an end stop device 117 is associated to the respective gravity compensator 114.1. The end stop device 117 is formed by a tube 117.1 the upper end of which faces the piston 114.3 while its lower end is mechanically connected to the base of structure 112.1 via two membrane elements 117.2. In case of a failure of the negative pressure supply to the negative pressure chamber the piston 114.3 will move towards the upper end of the tube 117.1 due to the weight of the lens 108.1.

Once the lower face of the piston 114.3 engages the upper end of the tube 117.1 the membrane elements 117.2 gradually build up forces acting in the vertical direction in order to slow down and stop the movement of the lens 108.1. The tube 117.1 and the membrane elements may also build up such forces in a horizontal plane such that movement of the lens having a horizontal component may also be slowed down and stopped. Thus, in other words, the end stop device 117 may damp the forces acting on the lens 108.1 in case of a failure of its support and avoid damage to the lens 108.1 in this case.

It will be appreciated that the end stop device may be of any other suitable design in order to fulfill this task. In particular, any other resilient and/or damping support may be selected for the part engaging the piston 114.3. Furthermore, it will be appreciated that the piston and/or the end stop device may have any suitable design which guarantees a proper force transmitting engagement in case of their contact upon a failure.

Finally, as can be seen from FIG. 2, the base structure 112.1 also forms support for a metrology arrangement 118 capturing the relative position of the lens 108.1 in relation to the base structure 112.1. This relative position of the lens 108.1 is then used to control the active positioning of the lens 108.1 via the actuator device 113.

It will be appreciated that the base structure 112.1 may be supported on a ground structure or a further base structure—not shown in FIG. 2—in a vibration isolated manner in order to avoid introduction of vibrations into the optical system.

It will be further appreciated that, in case the optical element 108.1 is a mirror or another optical element that is not optically used in its central area, instead of the distribution with three gravity compensation devices 114 and three actuator pairs 113.1 as described above, there may also be provided a single, centrally located gravity compensation device 114 and a plurality of actuators 113.2 associated thereto.

The gravity compensator 114.1 is then located such that the gravity compensation force line of its gravity compensation force F_{G}& extends through the center of gravity 108.2 of the optical element 108.1. The gravity compensation force F_{G}& then in itself fully compensates the gravitational force F_{G} acting on the optical element 108.1. The interface 116 then it is a rigid interface that is capable of transmitting forces and moments of the optical element 108.1 in up to six degrees of freedom (DOF).

An optical element module 21 1 which may replace the optical element module 111 in the exposure apparatus 101 of FIG. 1 will be described with reference to FIGS. 1 and 3.

The basic design and functionality largely correspond to FIG. 2 such that it is here at mainly referred to the differences only. As a consequence, like or identical parts have been given the same reference number raised by 100.

As can be seen from FIG. 3, the lens 208.1 is supported by a support structure 212 including a base structure 212.1, an actuator device 213 and a force exerting device in the form of a gravity compensation device 214 and an interface device in the form of a support ring 216. The lens 208.1 is connected to the support ring 216 via three or more leaf springs 219 evenly distributed at the perimeter of the lens 208.1.

The actuator device 213 includes two contactless actuators 213.2 similar to the ones described above. Each actuator 213.2 is mechanically connected to the base structure 212.1 and the support ring 216. The actuator devices 213 serve to accelerate and, thus, to position the lens 208.1 in one degree of freedom (DOF) while suitable guide mechanisms—not shown in FIG. 3—restrict the movement of the lens 208.1 in the five other degrees of freedom (DOF). The gravity compensation device 214 includes two gravity compensators 214.1. Each gravity compensator 214.1 is mechanically connected to the base structure 212.1 and the lens 208.1.

The actuators 213.2 and the gravity compensators 214.1 are evenly distributed at the perimeter of the lens 208.1. The distribution is such that the gravity compensation force lines of the individual gravity compensation forces F_{G}& exerted by the respective gravity compensator on the lens 208.1 lie in a common plane with the center of gravity (COG) 208.2 of the lens 208.1. Furthermore, the distribution is such that the actuator force lines of the individual actuator forces F_{A} exerted by the respective actuator on the lens 208.1 lie in a common plane with the center of gravity (COG) 208.2 as well.

Furthermore, the gravity compensation force lines and the actuator force lines are substantially parallel to each other and to the force line of the gravitational force F_{G} acting on the lens 208.1.

The gravity compensation device 214, in sum, exerts a total gravity compensation force F_{G}ct which counteracts and fully compensates the gravitational force F_{G} acting in the center of gravity (COG) 208.2 of the lens 208.1. Depending on the mass distribution of the lens 208.1 the individual gravity compensation forces F_{GCI} exerted by the respective gravity compensator on the lens 208.1 are chosen such that, together, they fully compensate and balance the static forces and moments acting on the lens 208.1 and the support ring 216, i.e. such that the equations (1) and (2) are fulfilled. It will be appreciated that, depending on the design of the actuators 213.2, eventually, this may also include forces and/or moments resulting from the weight of certain components of the actuator device 213 mechanically connected to the lens 208.1.

Each gravity compensator 214.1 again includes a cylinder 214.2 and a piston 214.3 slidably mounted within the cylinder 214.2. A piston rod 214.4 guided in a suitable bush of the cylinder 214.2 mechanically connects the piston 214.3 to the lens 208.1. The cylinder 214.2 and the piston 214.3 define a negative pressure chamber 214.5. Again a negative pressure source 214.6 provides a suitable negative pressure NP within the negative pressure chamber 214.5. This negative pressure is controlled and has been explained above.

Again, as can be also seen from FIG. 3, an end stop device 217 identical to the end stop device 117 of FIG. 2 is associated to the respective gravity compensator 214.1.

It will be appreciated that the base structure 212.1 may be supported on a ground structure or a further base structure—not shown in FIG. 3—in a vibration isolated manner in order to avoid introduction of vibrations into the optical system.

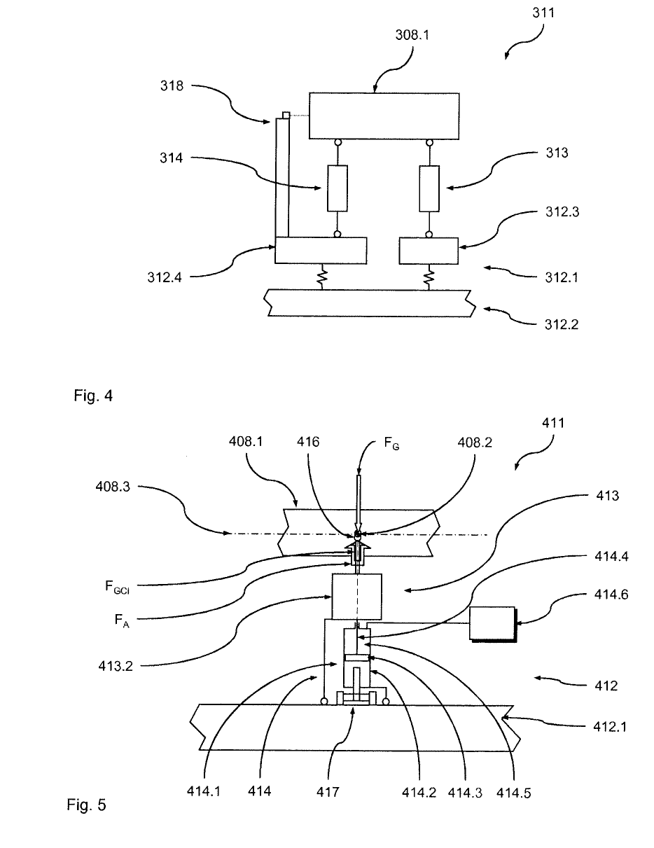

An optical element module 311 which may replace the optical element module 111 in the exposure apparatus 101 of FIG. 1 will be described with reference to FIG. 4.

The basic design and functionality largely correspond to FIG. 2 such that it is here at mainly referred to the differences only. As a consequence, like or identical parts have been given the same reference number raised by 200.

As can be seen from—highly schematic—FIG. 4, the lens 308.1 is supported by a support structure 312 including a base structure 312.1, an actuator device 313 and a force exerting device in the form of a gravity compensation device 314.

The base structure 312.1 includes a first base structure part 312.2 on which a second base structure part 312.3 and a third base structure part 312.4 are each supported in a vibration isolated manner. While the second base structure part 312.3 supports the actuator device 313, the third base structure part 312.4 supports the gravity compensating device 314 and the metrology arrangement 318. This has the advantage that the gravity compensating device 314 and the metrology arrangement 318 are dynamically decoupled from actuator device 313 reducing the overall vibration disturbances introduced into the system.

It will be appreciated that the gravity compensating device and the actuator device may be of any suitable design. In particular, they may be of the design as it has been described above.

An optical element module 411 which may replace the optical element module 111 in the exposure apparatus 101 of FIG. 1 will be described with reference to FIG. 5.

The basic design and functionality largely correspond to FIG. 2 such that it is here at mainly referred to the differences only. As a consequence, like or identical parts have been given the same reference number raised by 300.

As can be seen from FIG. 5, the lens 408.1 is supported by a support structure 412 including a base structure 412.1, an actuator device 413 and a force exerting device in the form of a gravity compensation device 414.

The actuator device 413 includes a plurality of contactless actuators 413.2 similar to the ones described above. Each actuator 413.2 is mechanically connected to the base structure 412.1 and the lens 408.1. The actuator device 413 serves to accelerate and, thus, to position the lens 408.1. The gravity compensation device 414 includes a plurality of gravity compensators 414.1. Each gravity compensator 414.1 is associated to an actuator 413.2 and mechanically connected to the base structure 412.1 and the lens 408.1.

Each actuator 413.2 and its associated gravity compensator 414.1 form a support unit. Furthermore, the actuator 413.2 and its associated gravity compensator 414.1 are arranged such that the gravity compensation force lines and the actuator force lines are substantially collinear to each other and parallel to the force line of the gravitational force F_{G} acting on the lens 408.1. To this end, the piston rod 414.4 of the gravity compensator 414.1 extends through a tube shaped actuator rod of the actuator 413.2. By this approach, a very compact arrangement may be achieved.

The actuator 413.2 and the associated gravity compensator 414.11 connected to the lens 408.1 and a common interface 416 located close to the neutral plane of deformation 408.3 of the lens 408.1. Herewith an advantageous introduction of loads into the lens 408.1 is achieved.

A suitable number of the support units formed by an actuator 413.2 and its associated gravity compensator 414.1 are evenly distributed at the perimeter of the lens 408.1. The gravity compensation device 414, in sum, exerts a total gravity compensation force F_{G}ct which counteracts and fully compensates the gravitational force F_{G} acting in the center of gravity (COG) 408.2 of the lens 408.1. Depending on the mass distribution of the lens 408.1 the individual gravity compensation forces F_{G}& exerted by the respective gravity compensator on the lens 408.1 are chosen such that, together, they fully compensate and balance the static forces and moments acting on the lens 408.1, i.e. such that the equations (1) and (2) are fulfilled. It will be appreciated that, depending on the design of the actuators 413.2, eventually, this may also include forces and/or moments resulting from the weight of certain components of the actuator device 413 mechanically connected to the lens 408.1.

Each gravity compensator 414.1 again includes a cylinder 414.2 and a piston 414.3 slidably mounted within the cylinder 414.2. A piston rod 414.4 guided in a suitable bush of the cylinder 414.2 mechanically connects the piston 414.3 to the lens 408.1. The cylinder 414.2 and the piston 414.3 define a negative pressure chamber 414.5. Again a negative pressure source 414.6 provides a suitable negative pressure NP within the negative pressure chamber 414.5. This negative pressure is controlled and has been explained above.

Again, as can be also seen from FIG. 3, an end stop device 417 identical to the end stop device 117 of FIG. 2 is associated to the respective gravity compensator 414.1.

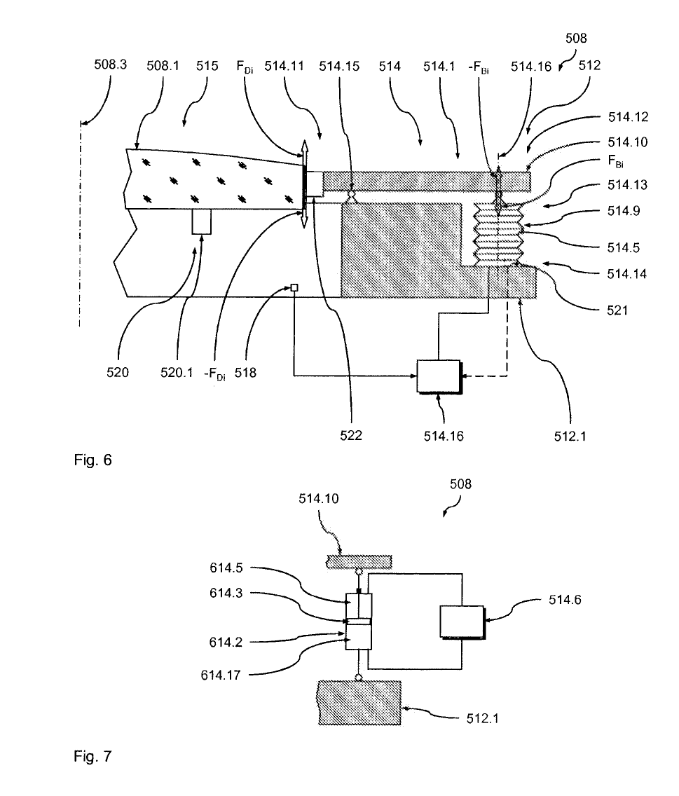

An optical element module 511 which may replace the optical element module 111 in the exposure apparatus 101 of FIG. 1 will be described with reference to FIGS. 1 and 6.

As can be seen from FIG. 6, a lens 508.1—shown in a highly schematic manner—forms part of the optical element module 511. The optical element module 511 includes a support structure 512 supporting the lens 508.1. The support structure 512, in turn, includes a base structure 512.1, a support device 520 and a force exerting device 514.

The support device 520 includes four passive support elements 520.1 (only one of them being shown in FIG. 6). However, it will be appreciated that, in some embodiments, any other number of support elements may be chosen as long as, together with other components of the support structure, a defined and stable support to the optical element is achieved.

Each of the support elements 520.1 is mechanically connected to the base structure 512.1 and to the outer perimeter of the lens 508.1. The support elements 520.1 may be connected to the lens 508.1 by any suitable mechanism. For example, the support elements 520.1 may be clamped to the outer perimeter of the lens 508.1. However, it will be appreciated that, in some embodiments, the connection between the support elements and the lens may be of any other suitable type, e.g. a frictional connection, a positive connection, an adhesive connection or any combination thereof.

Furthermore, the respective support elements 520.1 may provide mechanical decoupling in the radial direction of the lens 508.1 in order to allow compensation of thermally induced position alterations between the lens 508.1 and the base structure 512.1. Suitable mechanism(s) for providing such mechanical decoupling in the radial direction are all well-known in the art, e.g. from U.S. Pat. No. 4,733,945 (Bacich), the entire disclosure of which is incorporated herein by reference, such that this will not be explained here in further detail.

The support elements 520.1 are evenly distributed at the perimeter of the lens 508.1, i.e. mutually rotated by 90° about the optical axis 508.3 (not shown at its real location in FIG. 6) of the lens 508.1, in order to provide even support to the lens 508.1.

The force exerting device 514 includes four force exerting units 514.1 mechanically connected to the base structure 512.1 and the lens 508.1 (only one of them being shown in FIG. 6). However, it will be appreciated that, in some embodiments, any other number of force exerting units may be chosen as long as, eventually together with one or more support elements as they have been described above, a defined and stable support to the optical element is achieved.

The force exerting units 514.1 are evenly distributed at the outer perimeter of the lens 508.1 (i.e. mutually rotated by 90° about the optical axis 508.3 of the lens 508.1). Furthermore, the first locations where each force exerting unit 514.1 contacts in the lens 508.1, in the peripheral direction of the lens 508.1, is located substantially halfway between the two second locations where two neighboring support elements 520.1 contact the lens 508.1. Thus, an even distribution of the components of the support structure 512 contacting the lens 508.1 is achieved.

Each force exerting unit 514.1 includes a force exerting element in the form of a bellows 514.9 and a lever 514.10. The lever 514.10, at a first end 514.11, is connected by suitable connection mechanism 522 (shown in highly schematic way in FIG. 6) to a first location at the outer perimeter of the lens 508.1. For example, the lever 514.10 may be clamped via the connection mechanism 522 to the outer perimeter of the lens 508.1. However, it will be appreciated that, in certain embodiments, the connection mechanism may provide any other suitable connection between the lens and the lever, e.g. a frictional connection, a positive connection, an adhesive connection or any combination thereof.

At its second end 514.12, the lever 514.10 is mechanically connected to a first end 514.13 of the bellows 514.9. The second end 514.14 of the bellows 514.9, in turn, is mechanically connected to the base structure 512.1.

Between its first end 514.11 and its second end 514.12 the lever 514.10 is articulated via a hinge 514.15, e.g. via a flexure, to the base structure 512.1. The articulation via the hinge 514.15 is such that the lever 514.10 is pivotable about a pivot axis extending substantially tangential to the peripheral direction of the lens 508.1. Depending on the distance between the flexure 514.13 and the location of connection to the lens 508.1 and the bellows 514.9, respectively, a desired ratio of motion and/or force transmission may be achieved between the bellows 514.9 and the lens 508.1.

Similar to the support element 520.1, the connection mechanism 522 may provide mechanical decoupling in the radial direction of the lens 508.1. To this end, the connection mechanism 522 may, for example, include a flexure or a leaf spring element or any other spring element providing the radial decoupling function. Furthermore, as an alternative or in addition, the connection mechanism 522 may also provide a radial guide function.

On the one hand, this allows compensation of thermally induced position alterations between the lens 508.1 and the base structure 512.1. On the other hand, this radially flexible configuration allows for a mutual tilt between the lens 508.1 and the lever 514.10, thus reducing the introduction of bending moments (about an axis tangential to the peripheral direction of the lens 508.1) when the lever 514.10 is pivoted about the hinge 514.15. Such bending moments otherwise might, for example, promote undesired loads to the connection between the connection mechanism 522 and the lens 508.1.

The bellows 514.9, along a line of action 514.16 (substantially parallel to the optical axis 508.3), exerts a bellows force F₆, on the lever 514.10. In turn, via the lever 514.10, each force exerting unit 514.1 exerts a desired deformation force F_{DI} on the lens 508.1 which is also directed substantially parallel to the optical axis 508.3 of the lens 508.1 (or the optical axis 508.3 of an optical system including the lens 508.1 if the lens 508.1 is a plane parallel plate).

Depending on the shape and, thus, the mass distribution of the lens 508.1 and the forces exerted by the support elements 520.1, the individual deformation force F_{DI} exerted by the respective force exerting unit 514.1 on the lens 508.1 is chosen such that, together, they provide a desired deformation of the lens 508.1. In other words, via the deformation forces F_{DI} the first locations where the force exerting units 514.1 contact the lens 508.1 are displaced parallel to the optical axis 508.3 with respect to the second locations where of the support elements 520.1 contact the lens 508.1 leading to the desired deformation on the lens 508.1.

Such a deformation of the lens 508.1 may for example be used in a generally well-known manner for at least partly compensating imaging errors inherent to and/or introduced into the optical system of the optical exposure apparatus 101. It will be appreciated that, in some embodiments, depending on the deformation of the optical element to be achieved, any other suitable number and/or distribution of support elements and/or force exerting units may be chosen.

In particular, passive support elements may be even omitted and the support to the optical element may be provided exclusively via force exerting units. Under these circumstances, the deformation forces introduced into the optical element may also account for a shift in the position of an optical reference of the optical element (e.g. the focal point of the optical element) associated therewith. In other words, it is even possible to achieve a desired position of such an optical reference of the optical element (e.g. keep this position unchanged) while at the same time providing a desired deformation of the optical element.

To provide the deformation forces F_{DI}, the respective bellows 514.9 defines a negative pressure chamber 514.5. A negative pressure source 514.6 provides a suitable negative pressure NP within a gaseous working medium provided to the negative pressure chamber 514.5. This negative pressure provided by the negative pressure source 514.6 corresponds to a negative pressure setpoint value NP_{S} which is selected such that, under static load conditions, the desired individual deformation force F_{DI} as outlined above is exerted via the force exerting unit 514.1 on the lens 508.1.

The negative pressure source 514.6 includes a simple pressure control which controls the negative pressure NP using the negative pressure setpoint value NP_{S}. In other words, the pressure control tries to maintain the negative pressure NP within the negative pressure chamber 514.5 as close as possible to the negative pressure setpoint value NP_{S} at any time.

It will be appreciated that the pressure provided within the pressure chambers 514.5 may be the same for all the force exerting units 514.1 (e.g. by providing the pressure via a common pressure line). Optionally, the pressure source 514.6 is adapted to provide different individual pressure values (e.g. via a separate pressure lines) within selected ones of the pressure chambers 514.5.

The pressure control may be fully integrated within the pressure source 514.6. However, it is also possible, for example, that a suitable pressure sensor of the pressure control is provided within or close to the bellows 514.9 (as it is indicated in FIG. 6 by the dashed contour 521) in order to reduce the reaction time of the control.

The pressure source 514.6 optionally (but not necessarily) is also arranged to act as a positive pressure source providing a positive pressure to pressure chamber 514.5 of the bellows 514.9. By this approach it is possible to exert the above deformation force F_{DI} as a first force on the lens 508.1 when a negative pressure NP prevails within the pressure chamber of 514.5 and to exert an opposite bellows force—F_{BI} and, thus, an opposite deformation force—F_{DI} as a second force on the lens 508.1 when a positive pressure PP prevails within the pressure chamber of 514.5 (then being a positive pressure chamber).

By this approach, it is possible to achieve a wide range of deformation of the lens 508.1. In particular, deformation in both directions from a neutral state of the lens 508.1 with no deformation forces introduced via the force exerting units 514.1 may be achieved using one single bellows 514.9 per location of deformation. Furthermore, it is possible to actively reverse the deformation of the lens 508.1 using one single bellows 514.9 per location of deformation.

The control of the pressure within the pressure chamber 514.5 may be provided by the pressure source 514.6 at any desired bandwidth depending on the desired dynamic properties of the deformation of the lens 508.1 to be achieved.

Thanks to the use of a negative pressure the force exerting device 514 has very short reaction times and thus very good dynamic properties. This is due to the fact that, as already outlined above, only a rather low mass of working medium is to be conveyed within the negative pressure chamber 514.5, within the negative pressure lines connecting the pressure chamber 514.5 and the pressure source 514.6 and within the components of the pressure source 514.6 when acting on the lens 508.1. Thus, a low inertia and a low internal friction on the working medium is to be dealt with leading to improved dynamic properties of the system.

It will be appreciated that the negative pressure NP is provided to be negative in relation to the pressure prevailing in the atmosphere 515 outside the negative pressure chamber 514.5 and surrounding the lens 508.1. Optionally a negative pressure of down to −0.8 bar (e.g., down to −0.7 bar) is chosen. If the pressure source is also used as a positive pressure source providing a positive pressure PP (the pressure being positive in relation to the pressure prevailing in the atmosphere 515 outside the pressure chamber 514.5 and surrounding the lens 508.1), a positive pressure of up to +0.5 bar (e.g., up to +0.7 bar) is chosen.

Furthermore, the use of the negative pressure NP simply eliminates potential contamination problems since there is no material transport through leakage points of the pneumatic system towards the atmosphere 515 surrounding the lens 508.1. On the contrary, if any, there is only material transport from the atmosphere 515 towards the negative pressure chamber 514.5.

However, it will be appreciated that, in certain embodiments, it may be provided that there is no material flow between the negative pressure chamber and the atmosphere surrounding it, e.g. by providing suitable seals such as highly compliant membrane seals or the like. In this case the negative pressure within the negative pressure chamber may also be only negative in relation to an atmosphere prevailing within a further pressure chamber within the cylinder and lying on the opposite side of the piston. This further pressure chamber is then also sealed from the atmosphere surrounding the lens.

The geometry of the lens 508.1 may be changed within a wide range within a very short time in the range of down to a few milliseconds (e.g., 200 ms, 20 ms, 2 ms).

Finally, as can be seen from FIG. 6, the base structure 512.1 also forms support for a metrology arrangement 518 capturing the deformation and relative position of the lens 508.1 in relation to the base structure 512.1. The information on the deformation of the lens 508.1 is provided to the pressure source 514.6 and used for the control of the pressure provided by the pressure source 514.6. The information on the relative position of the lens 508.1 may be used to control an eventual active positioning of the lens 508.1. Such a position control may for example be provided by an actuating device positioning the base structure 512.1.

It will be appreciated that the base structure 512.1 may be supported on a ground structure or a further base structure—not shown in FIG. 6—in a vibration isolated manner in order to avoid introduction of vibrations into the optical system.

It will be further appreciated that, in case the optical element 508.1 is a mirror or another optical element that is not optically used in its central area, instead of the distribution with a plurality of force exerting units 514.1 that the outer perimeter of the optical element as described above, there may also be provided a single, centrally located force exerting device 514.

Furthermore, it will be appreciated that, in some embodiments, any other orientation in space of the force exerting device and/or of the force exerted by the force exerting device on the optical element may be chosen. For example, the force exerted on the optical element may have at least a force component in a radial and/or tangential direction of the optical element.

Furthermore, any other suitable design of the force exerting device and force exerting units may be chosen. For example, the force exerting unit may simply consist of the bellows acting directly on the optical element (i.e. without any further transmission mechanism located in between). It will be also appreciated that a cylinder and piston configuration may be chosen instead of the bellows to define the pressure chamber.

In particular, as it is shown in FIG. 7, a cylinder and piston configuration defining two pressure chambers (e.g. on both sides of the piston) may be chosen. FIG. 7 shows the optical element module 508 of FIG. 6 in a configuration where the bellows 509 is replaced by such an arrangement with a cylinder 614.2 and a piston 614.3.

The piston 614.3 is slidably mounted within the cylinder 614.2. A piston rod 614.4 guided in a suitable bush of the cylinder 614.2 mechanically connects the piston 614.3 to the lever 514.10. The cylinder 614.2 and the piston 614.3 define two negative pressure chambers, a first negative pressure chamber 614.5 and a second negative pressure chamber 614.17. Apart from that, the cylinder 614.2 and the piston 614.3 largely correspond to the above description.

The negative pressure source 514.6 then provides a suitable first negative pressure NP₁ within the first negative pressure chamber 614.5. and a second negative pressure NP₂ within the second negative pressure chamber 614.17. In other words, in this case, the negative pressure source 514.6 is adapted to independently control the negative pressure level within the first negative pressure chamber 614.5 and the negative pressure level within the second negative pressure chamber 614.17 according to the desired direction and amount of the force F_{DI} to be exerted on the lens 508.1.

By this approach it is possible to provide force exertion in opposite directions using exclusively negative pressures in both pressure chambers, i.e. without the need for providing a positive pressure as it has been described above in the context of the bellows 514.9.

Finally, it may be provided that the force exerting device does not act directly on the optical element but on a deformable holding structure (e.g. a deformable holding ring or the like) to which the optical element is connected.

In the foregoing, the disclosure has been described in the context of operating at a wavelength of 193 nm mainly with refractive optical elements. However, it will be appreciated that, in some embodiments working at different wavelengths, in particular also in the EUV range, the use of other types of optical elements (e.g. mirrors, gratings) is possible as well.

Furthermore, the disclosure has been described in the context of contactless actuator devices such as voice coil motors (Lorentz actuators). However, it will be appreciated that, in some embodiments, it is also possible to apply the disclosure in a configuration where any other type of actuator is used for adjusting the position of the respective optical element.

Furthermore, the disclosure has been described in the context of adjusting the position of an optical element in a rather large positioning range which is achievable under satisfying dynamic conditions thanks to the use of the negative pressure. However, it will be appreciated that, with smaller positioning ranges as they are often desired for the position adjustment of optical elements in the optical projection system, it is also possible to realize the geometric configurations described above with mechanical and/or magnetic gravity compensators as they have been described initially.

Furthermore, the disclosure has been described in the context of adjusting the position of an optical element of an illumination system. However, it will be appreciated that, in some embodiments, it is also possible to apply the disclosure to an optical element of the optical projection system or any other part of an optical exposure apparatus.

In the foregoing, the disclosure has been described only in the context of microlithography applications. However, it will be appreciated that the disclosure may be used in the context of any other imaging process.

What is claimed is:

1. An optical element module, comprising:
an optical element; and
a support structure supporting the optical element, the support structure comprising a force exerting device that is mechanically connected to the optical element and adapted to exert a force on the optical element when a negative pressure is acting within the force exerting device.

2. The optical element module according to claim 1, wherein the force exerting device is mechanically connected to the optical element at a first location, the support structure comprises at least one support device mechanically connected to the optical element at a second location different from the first location, and the force exerting device is adapted to introduce a deformation into the optical element by displacing the first location with respect to the second location.

3. The optical element module according to claim 2, wherein the force exerting device comprises a first component mechanically connected to the optical element at the first location, and the force exerting device comprises a second component mechanically connected to the optical element at the second location.

4. The optical element module according to claim 1, wherein:
the force exerting device comprises an element selected from the group consisting of a bellows and a cylinder element with a piston element arranged within the cylinder element;
when present, the bellows defining a negative pressure chamber;
when present, the bellows is mechanically connected to the optical element and adapted to exert the force on the optical element when the negative pressure is acting within the negative pressure chamber;
when present, the cylinder element and the piston element being movable relative to each other and defining a negative pressure chamber; and
when present, an element selected from the group consisting of the piston element and the cylinder element is adapted to be mechanically connected to the optical element and to exert at least a part of the force on the optical element when the negative pressure is acting within the negative pressure chamber.

5. The optical element module according to claim 4, wherein the force exerting device comprises the cylinder element and the piston element, a gap is present between the cylinder element and the piston element, and the gap is adapted to allow a slight flow of a medium forming an atmosphere external to the negative pressure chamber into the negative pressure chamber when the negative pressure prevails within the negative pressure chamber.

6. The optical element module according to claim 1, wherein the optical element has an outer perimeter, the force exerting device has a plurality of components, and at least a part of the plurality of components of the force exerting device are substantially evenly distributed that the outer perimeter.

7. The optical element module according to claim 1, wherein the optical element is an optical element of a microlithography device, or the optical element is an optical element of an illumination device of a microlithography device.

8. The optical element module according to claim 1, wherein:
the support structure comprises an actuator device mechanically connected to the optical element;
the actuator device is adapted to exert an actuation force on the optical element to accelerate the optical element;
the force exerting device is a gravity compensator of a gravity compensation device;
the gravity compensator is adapted to exert a gravity compensation force on the optical element when a negative pressure is acting within the gravity compensator; and
the gravity compensation force counteracts at least a part of the gravitational force acting on the optical element.

9. The optical element module according to claim 8, wherein the gravity compensation force substantially compensates the gravitational force acting on the optical element.

10. The optical element module according to claim 8, wherein the gravity compensation device comprises a negative pressure source, and the negative pressure source is adapted to generate the negative pressure within a working medium acting within the gravity compensator to generate the gravity compensation force.

11. The optical element module according to claim 10, wherein the gravity compensation device comprises a negative pressure control device, and the negative pressure control device is adapted to control the negative pressure source such that the negative pressure is maintained substantially constant during actuation of the optical element via the actuator device.

12. The optical element module according to claim 8, wherein the gravity compensator is adapted to follow a travel distance of the optical element at a substantially constant gravity compensation force, and the travel distance is at least 10 millimeters.

13. The optical element module according to claim 8, wherein the gravity compensator is adapted to follow a travel of the optical element at a substantially constant gravity compensation force within 2 seconds or less.

14. The optical element module according to claim 8, wherein:
the gravity compensator is adapted to exert at least a part of the gravity compensation force on the optical element along a gravity compensation force line;
the actuator device comprises an actuator adapted to exert the actuation force on the optical element along an actuation force line; and
the gravity compensation force line and the actuation force line intersect at an intersection point, are substantially parallel, and/or are substantially collinear.

15. The optical element module according to claim 14, wherein the intersection point is located close to a mechanical interface where the gravity compensator and/or the actuator is connected to the optical element.

16. The optical element module according to claim 8, wherein:
the optical element has a center of gravity;
the gravity compensation device is adapted to exert the gravity compensation force on the optical element along a gravity compensation force line;
the actuator device is adapted to exert the actuation force on the optical element along an actuation force line; and
the actuator device and the gravity compensation device being arranged such that the gravity compensation force line extends through the center of gravity of the optical element and/or the actuation force line extends through the center of gravity of the optical element.

17. The optical element module according to claim 8, wherein the actuator device comprises at least one Lorentz actuator.

18. The optical element module according to claim 8, further comprising an end stop device adapted to limit gravity induced movement of the optical element in case of a failure of the gravity compensation device.

19. The optical element module according to claim 18, wherein:
the end stop device is adapted to damp reaction forces acting on the optical element when limiting gravity induced movement of the optical element in case of a failure of the gravity compensation device; and/or
the end stop device is associated to at least one of the gravity compensation device and the actuator device.

20. An apparatus, comprising:
an illumination system;
an optical projection system; and
an optical module in the illumination system or the optical projection system, the optical module comprising an optical element and a support structure supporting the optical element, the support structure comprising a force exerting device mechanically connected to the optical element and adapted to exert a force on the optical element when a negative pressure is acting within the force exerting device,
wherein the apparatus is an optical exposure apparatus configured to transfer an image of a pattern formed on a mask onto a substrate.

21. The apparatus according to claim 20, wherein:
the support structure comprises an actuator device mechanically connected to the optical element;
the actuator device is adapted to exert an actuation force on the optical element to accelerate the optical element;
the force exerting device is a gravity compensator of a gravity compensation device;
the gravity compensator is adapted to exert a gravity compensation force on the optical element when a negative pressure is acting within the gravity compensator; and
the gravity compensation force can counteract at least a part of the gravitational force acting on the optical element.

22. A structure, comprising:
an optical element; and
a force exerting device adapted to be mechanically connected to the optical element and to exert a force on the optical element when a negative pressure is acting within the force exerting device.

23. The structure according to claim 22, further comprising an actuator device, wherein:
the force exerting device is a gravity compensator of a gravity compensation device;
the actuator device is adapted to be mechanically connected to the optical element and to exert an actuation force on the optical element to accelerate the optical element;
the gravity compensator is adapted to exert the force as a gravity compensation force on the optical element when a negative pressure is acting within the gravity compensator; and
the gravity compensation force can counteract at least a part of the gravitational force acting on the optical element.

24. The structure according to claim 23, wherein the gravity compensator is adapted to follow a travel distance of the optical element at a substantially constant gravity compensation force, and the travel distance being is at least 10 millimeters.

25. The structure according to claim 24, wherein the gravity compensator is adapted to follow the travel of the optical element at a substantially constant gravity compensation force within 2 seconds or less.

26. A method, comprising:
using negative pressure to exert a force on an optical element to support the optical element.

27. The method according to claim 26, wherein the force is exerted on the optical element at a first location, the optical element is supported at a second location different from the first location, and the method comprises deforming the optical element by displacing the first location with respect to the second location.

28. The method according to claim 26, wherein the force exerted on the optical element counteracts at least a part of a gravitational force acting on the optical element and/or substantially compensates a gravitational force acting on the optical element.

29. The method according to claim 28, wherein:
an actuation force is exerted on the optical element via an actuator device to accelerate the optical element; and/or
the negative pressure is maintained substantially constant during actuation of the optical element via the actuator device.

30. The method according to claim 28, wherein a travel distance of the optical element is generated via the actuator device, the travel distance is at least one of at least 10 millimeters, and the gravity compensation force is substantially constant when generating the travel of the optical element.

31. The method according to claim 30, wherein the travel is generated within than 2 seconds or less.

32. The method according to claim 28, wherein:
at least a part of the gravity compensation force is exerted on the optical element along a gravity compensation force line;
an actuation force accelerating the optical element is exerted along an actuation force line on the optical element via an actuator device; and
the gravity compensation force line and the actuation force line intersect at an intersection point, are substantially parallel, and/or being substantially collinear.

33. The method according to claim 26, wherein the negative pressure is continuously adjusted at a bandwidth of less than 5 Hz.

34. The method according to claim 28, wherein an actuation force is exerted on the optical element via an actuator device to accelerate the optical element, and the negative pressure is continuously adjusted as a function of an operational parameter of the actuator device for reducing the power consumed by the actuator device.

35. The method according to claim 34, wherein the actuator device comprises an electrical actuator, and the operational parameter is a current taken by the electrical actuator.
